(19) United States
(12) Patent Application Publication
(10) Pub. No.: US 2019/0311046 A1
(43) Pub. Date: Oct. 10, 2019

(54) INTERACTIVE PRESENTATION APPARATUS AND METHOD

(71) Applicant: Geoffrey S. Stern, Westport, CT (US)

(72) Inventor: Geoffrey S. Stern, Westport, CT (US)

(21) Appl. No.: 15/947,504

(22) Filed: Apr. 6, 2018

(51) Int. Cl. G06F 17/30; G10L 15/26; G06F 3/16

(52) U.S. Cl. CPC G06F 17/30056; G06F 3/167; G10L 15/265

(57) ABSTRACT

A presentation apparatus contains an electronic media player and, through voice recognition, responds to a user's voice utterances to adapt the presentation in accordance with the user's voice responses. That is, the device will either play predetermined media in response to a recognized phrase or prompt the user further for a voice response to navigate through multiple levels of available playback material.

This patent application claims the benefit of the filing date of U.S. Provisional Patent Application No. 62/486,032, filed 17 Apr. 2017, the entirety of which is incorporated herein by reference.

### BACKGROUND OF THE INVENTION

The present invention relates generally to a presentation apparatus and, more particularly, concerns an interactive electronic presentation apparatus and method.

Electronic presentation devices are known in the art. These have been used for merchandising and have been available as talking cards, musical cards, video displays an at the point-of-sale, and they have been incorporated into magazines, sales collateral packaging, and in-store displays. When such presentation devices and electronically enhanced printed material contain more than one media file, the user must either listen to or view the files in a predetermined sequence, or he may be provided with navigational buttons embedded in the printed matter or display which enable him to select particular media for playback. Alternately, the navigational buttons may permit the user to move forward or backward between files. However, manual navigation by the user significantly limits the number of media files that can be presented, and it is not possible to provide a very comprehensive presentation to the user, or a presentation that actually meets his individual needs.

Presentation devices arc also known which include an auto-dial wireless cellular modem or the ability to connect to the Internet through a wireless local area network or a mobile phone application, allowing the provider of the presentation device (or third-party) to have a live, interactive exchange with the user after the presentation device is activated. Also, there may be connected a chatbot (a computer program which conducts a conversation via auditory or textual methods). The user can thereby receive text, data, e-mail onto his mobile phone or telephone communications from a representative of the source of the presentation device. However, such “connected” merchandising products are designed to make a single connection to a general address, such as an e-mail address or a live call center, and the user must then be redirected to an appropriate department or helpdesk. If the user has some questions about sophisticated subject matter, he may experience some difficulty and frustration before being able to communicate with a knowledgeable expert or before receiving the appropriate information or data. Furthermore, “connected” devices connect automatically with a cellular network, which could be considered an invasion of privacy by the user. Also, the availability and reliability of a connection depends upon geographical coverage of the cellular provider.

In accordance with the present invention a presentation device contains an electronic media player and, through voice recognition, responds to the user's voice utterances to adapt the presentation in accordance with the user's voice responses. That is, the device will either play predetermined media in response to a recognized phrase, or it will prompt the user further for a voice response to navigate through multiple levels of available playback material. Preferably, the device generates and stores an “information ID” corresponding to the sequence of his responses. When communicating with the representative of the provider of the device, whether by telephone, e-mail or online, the user can provide the information ID, or the device can transmit the information ID, and be connected directly with an appropriate expert, who will be aware of the user's interests and will be able to offer specific expert information. Alternately, the device can automatically retrieve the appropriate data or requested files.

### BRIEF DESCRIPTION OF THE DRAWINGS

The foregoing brief description and further objects, features and advantages of the present invention will be understood more completely from the following detailed description of a presently preferred, but nonetheless illustrative, embodiment in accordance with the present invention, with reference being had to the accompanying drawings, in which:

FIG. 1 is a functional block diagram of an electronic promotional apparatus 10 embodying the present invention;

FIG. 2 is a flowchart illustrating the process of performing an interactive presentation for a user;

FIG. 3 functional block diagram of an electronic promotional apparatus 110 embodying the present invention;

FIG. 4 is a flowchart illustrating the changes to be made to the flowchart of FIG. 2 for promotional device 110; and

FIG. 5 is a block diagram of a presentation apparatus in accordance with the present invention.

### DETAILED DESCRIPTION

The preferred embodiment of the invention is an electronic device providing an interactive presentation to a user. For example, the device could be embedded in promotional materials, such as a card or booklet, provided by a pharmaceutical company to a medical doctor to promote a new product. Once turned on, the device presents a program to the user (doctor), recognizes the user's voice expressions and modifies the presentation in response to them.

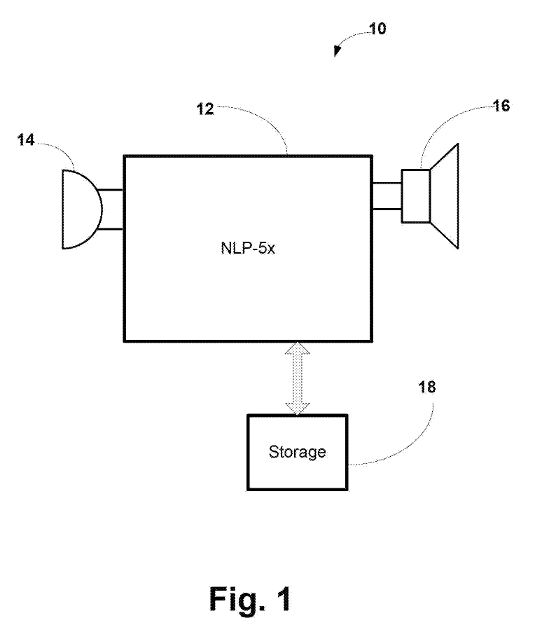

FIG. 1 is a functional block diagram of an electronic promotional apparatus 10 embodying the present invention. Conventional components, such as a power source, are not shown. A major component of apparatus 10 is an NLP-5x natural language processor 12 available from Sensory, Inc. of Sunnyvale, Calif. The NLP-5x is a sophisticated digital signal processor capable of performing speaker-independent voice recognition of signals provided to it through a directly connected microphone 14, and it can provide audio output to a directly connected speaker 16. It is also capable of text-to-voice conversion and can therefore recite stored text messages. Content for a presentation is stored in electronic storage 18 (for example ROM), which is in communication with processor 12. The content includes not only voice presentations, but supporting content, such as music or audio recordings. Processor 12 is programmed to perform the presentation, recognize user responses uttered into microphone 14, and select content based upon those responses.

In operation, device 10 presents content to the user through speaker 16 and processor 12 is programmed to pause for an expected voice response. The user's reply is picked up by microphone 14, voice-recognized by processor 12, and further presentation proceeds under control of processor 12 in accordance with the user's voice responses. Device 10 contains a unique serial number and generates and stores (in internal memory of processor 12) an information ID based upon the user's responses. Thus, an expert advisor, working with the user, is later able to determine what program was presented to the user and what responses he made, based upon the serial number and information ID.

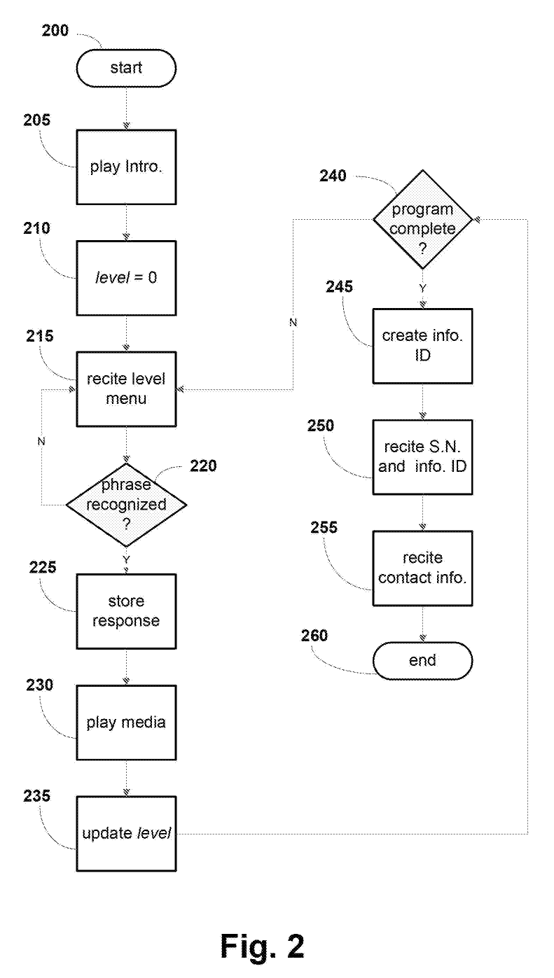

FIG. 2 is a flowchart illustrating the process of performing an interactive presentation for the user. The process begins at block 200 and proceeds to block 205, where an introduction is recited from the stored presentation in memory. At block 210 an index variable “level” is set to zero, and control passes to block 215, where a menu is recited by the device, which menu is associated with the current value of level. The menu is a set of phrases, each representing an option for the next subject matter which can be recited. The device then listens for the user's response, performing a test at block 220 to determine whether the phrase recited by the user is recognized. If it is not recognized, Control returns to block 215, where the level menu is repeated. It will therefore be appreciated that the user can always have the level menu repeated by simply saying “repeat.”

If the phrase is recognized at block 220, the response is stored in internal memory at block 225 and, at block 230, media is played from memory based upon the user's response. At block 235, the value of level is then updated based upon the user's response. At block 240 a test is then performed to determine whether the user has completed the program and, if not, control returns to block 215 for the recitation of the menu at the new level, voice recognition and the next presentation.

If it is determined at block 240 that the user has completed the program, an information ID is created and stored at block 245 which encodes the entire sequence of the user's responses. At block 250, the device presents or recites a unique stored serial number associated with it and also presents or recites the information ID. At block 255, the device presents or recites contact information for the provider of the device, which may include Internet contact information, and the process ends at block 260.

The contact information includes the provider's telephone number, email address and a live chat address. When using any of them, the user provides the device serial number and information ID and he will be connected with an expert knowledgeable in the specific subject matter that was presented to him. It is also contemplated that the device would be accompanied by a return postcard containing the user's contact information, spaces for the user's input of the information ID and the device serial number. This would be an alternate method for an appropriate expert to contact the user. Knowing the serial number of the device 10, the expert would know what presentation the user has experienced, and knowing the information ID the expert would know what specific responses the user has given and what actual information was presented to him. It is also contemplated that the device would be provided with printed instructions for the recipient to establish an internet connection with a wireless local area network, or by pairing the device with the recipient's mobile phone.

When the device 10 is first turned on, the user will be provided with a recited utility menu permitting him to play the serial number and information ID, to play the device provider's contact information, and to play the program.

Those skilled in the art will appreciate that apparatus 10 can easily be enhanced to provide video and pictorial information. It is only necessary to provide a solid-state micro-display and driver which receive information from storage 18 under control of processor 12.

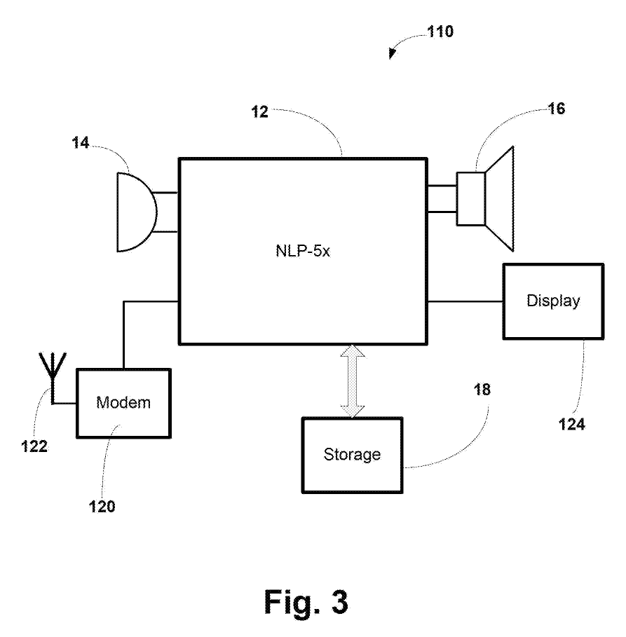

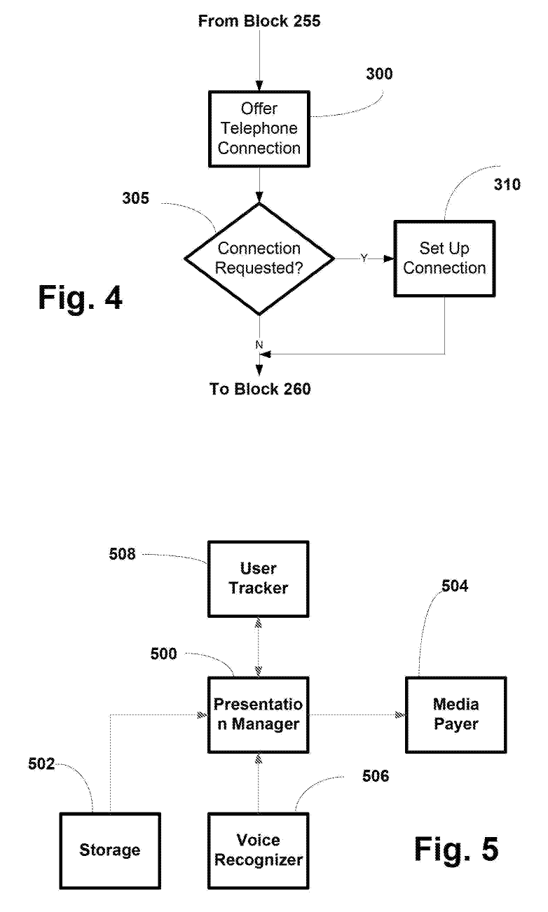

Those skilled in the art will also appreciate that apparatus 10 could he provided with a modem 122 and antenna 124, like device 110 of FIG. 3. Processor 12 would then be programmed to offer the user a telephone connection, with the source of apparatus 10, between blocks 255 and 260 in FIG. 2 (as illustrated in FIG. 4). With the telephone connection operative, the user would make use of microphone 14 and speaker 16. The user could also make use of a direct electronic interact connection or a internet connection via a mobile phone application with the source of apparatus 10, between blocks 255 and 260 in FIG. 2 (as illustrated in FIG. 4). With the internet connection operative, the user would make use of microphone 14 and speaker 16 to interact with a computer program which conducts a conversation via auditory or textual methods and which could provide additional media and data to the recipient via e-mail SMS or MMS text.

FIG. 3 is a functional block diagram of an electronic promotional apparatus 110, alternate embodiment of the present invention. Conventional components, such as a power source, are not shown. Components which are similarly numbered to FIG. 1 are identical and operate in the same manner. In addition to the components of apparatus 10, apparatus 110 has a modern 122, with an antenna 124, connected to processor 12. In operation, this makes it possible to establish communication with the internet and to retrieve and deliver appropriate pictorial and video information to be presented as part of the presentation and to establish a direct telephone communication between the user and a live operator or chatbot.

It is contemplated that apparatus 110 would be used at a point-of-sale. It has therefore been provided with a display screen 126 under control of processor 12. Storage 18 contains appropriate pictorial and video information to be presented as part of the presentation. For example, the user may wish to purchase a new cell phone. After completing the presentation, the user is connected via his existing cell phone to a service person, who will answer any remaining questions, knowing the results of the presentation, and who will then join him at the point of sale, with samples of recommended telephones.

Operation is as illustrated in the flowchart of FIG. 2, except blocks are added between blocks 255 and 260 related to setting up a telephone connection, as illustrated in the flowchart of FIG. 4. At block 300, the presentation offers the user a telephone connection and, at block 305, a test is performed to determine if the connection was requested by the user. If not, control transfers to block 260. If a connection was requested, the connection is set up at block 310, and control transfers to block 260.

Summarizing, the invention provides a presentation apparatus, which is interactive and adaptive depending upon user responses. FIG. 5 is a block diagram of a presentation apparatus in accordance with the present invention. A presentation manager 500 receives multimedia information from storage 502 and presents the information to media player 504 for presentation to a user. Upon completion of an initial sub-presentation, presentation manager 500 pauses and prompts the user for an oral response, either by presenting a menu of possible responses, or receiving a freestyle response. The user's voice response is sensed by voice recognizer 506 and controls presentation manager 500 in selecting the next sub-presentation. At the conclusion of every sub-presentation, presentation manager 500 similarly prompts the user, and the user's voice responses, as detected by voice recognizer 506, determine the progress of the presentation, until it is completed. Preferably, each time presentation manager 500 is informed of a voice instruction by voice recognizer 506, it notifies user tracker 508 of the user's instruction, and the tracker 508 remembers all of the instructions. When the presentation is completed, tracker 508 generates and saves an “information ID” representing the entire sequence of user responses.

Although preferred embodiments of the invention have been disclosed for illustrative purposes, those skilled in the art will appreciate that many additions, modifications and substitutions can be made, without departing from the scope and spirit of the invention as defined by the accompanying claims.

What is claimed:

1. A presentation apparatus presenting an adaptive multimedia presentation to a user, comprising:
a voice recognizer sensing the uses voice;
storage containing audio, visual and video information for the presentation;
a presentation manager drawing information from storage and being responsive to the voice recognizer; and
a media, player controlled by the presentation manager;
wherein the presentation manager provides an initial sub-presentation, pauses and prompts the user for response, the user's response, as sensed by the voice recognizer, controlling the next sub-presentation presented by the presentation manager to the media player.

2. The presentation apparatus of claim 1, wherein the presentation manager prompt includes a menu of available sub-presentations to be performed next.

3. The presentation apparatus of claim 1, wherein the presentation manager pauses and prompts the user after said next sub-presentation, the user's response, as sensed by the voice recognizer controlling a further sub-presentation presented by the presentation manager to the media player.

4. The presentation apparatus of claim 3 wherein the presentation manager pauses and prompts the user after each of a plurality of further sub-presentations, the user's response to such prompts, as sensed by the voice recognizer, each time, controlling a the next sub-presentation presented by the presentation manager to the media player.

5. The presentation apparatus of claim 3 further comprising a user tracker generating and saving an information ID representing the sequence of user responses to prompts from the presentation manager.

6. The presentation apparatus of claim 1 further comprising a user tracker generating and saving an information ID representing the sequence of user responses to prompts from the presentation manager.

7. The apparatus of claim 1 further comprising a communications modem with antenna, enabling, the apparatus to have telephone communications.

8. The apparatus of claim 1 further comprising a communications modem with antenna, enabling the apparatus to connect to the Internet using a wireless local area network.

9. A method for use in a presentation apparatus to present an adaptive multimedia presentation to a user, comprising the steps of:
(a) presenting an initial sub-presentation to the user;
(b) prompting the user for a voice response;
(c) performing voice recognition on said voice response; and
(d) presenting a next sub-presentation to the user, based upon the voice recognized response.

10. The method of claim 9, wherein steps (b) through (d) are performed a plurality of times.

11. The method of claim 9, wherein steps (b) through (d) are performed for each sub-presentation presented to the user.

12. The method of claim 9, wherein voice-recognized responses are utilized to generate an information ID representative of the sequence of the user's responses in presentation session.

13. The method of claim 12, wherein all voice-recognized responses are utilized to generate an information ID representative of the sequence of the user's responses in presentation session.

14. The method of claim 9, further comprising providing a communications modem with antenna, whereby the presentation apparatus can provide remote communication.

15. The method of claim 9, comprising providing the presentation apparatus to an individual.

16. The method of claim 9, comprising providing the presentation apparatus at a point-of-sale.
